(19) United States
(12) Patent Application Publication
(10) Pub. No.: US 2016/0277984 A1
(43) Pub. Date: Sep. 22, 2016

(54) Selectively Utilising Mobility of IP Flows

(71) Applicant: TELEFONAKTIEBOLAGET L M ERICSSON (PUBL), Stockholm (SE)

(72) Inventors: Dinand Roeland, Sollentuna (SE); Tomas Hedberg, Stockholm (SE); Stefan Rommer, Västra Frölunda (SE); Jari Vikberg, Järna (SE)

(21) Appl. No.: 14/410,171

(22) PCT Filed: Nov. 7, 2014
(86) PCT No.: PCT/SE2014/051326

§ 371 Date: Dec. 22, 2014

(51) Int. Cl. H04W 36/14; H04W 40/36; H04W 36/00; H04W 36/30

(52) U.S. Cl. CPC H04W 36/14; H04W 36/30; H04W 40/36; H04W 36/0016; H04W 84/12

(57) ABSTRACT

It is presented a method for selectively utilising mobility of IP flows. The method is performed in a PGW, and comprises the steps of: establishing an IFOM packet data network connection for a mobile terminal using both a first access network, being a 3GPP network, and a second access network, being a non-3GPP network; receiving an IFOM recommendation message for the mobile terminal from a radio access node of the first access network or a radio access node of the second access network, the IFOM recommendation message comprising an indication of recommended access network for at least one IP flow of the mobile terminal; moving at least one IP flow from the first access network to the second access network, or vice versa, in response to receiving the IFOM recommendation message, wherein each one of the at least one IP flow corresponds to a routing filler.

### TECHNICAL FIELD

The invention relates to mobility of IP (Internet Protocol) flows, and more particularly in selecting access network to utilise when IP flow mobility is possible.

### BACKGROUND

Cellular networks have evolved from being primarily a voice service to more and more a data service. With the proliferation of devices that have support for both Wireless Local Area Networks (WLAN) and cellular networks such as 3GPP (Third Generation Partnership Project) networks, moving traffic between 3GPP and non-3GPP networks, such as WLAN, is gaining increased interest both from user and operator perspectives.

There are a number of initiatives in this field, one of them being a 3GPP initiative for IP Flow Mobility (IFOM) as described in the technical specifications 3GPP TS 23.402 and 3GPP TS 23.261. Using IFOM, IP flows can be moved between WLAN and 3GPP networks. Moreover, IP address preservation and session continuity is provided when moving IP flows from one access network to the other. The decision whether to move an IP flow can be performed in a node called a Packet Data Network Gateway (PGW).

However, the basis upon which the PGW decides the access network to use is rather rudimentary and any improvement would be of great benefit.

### SUMMARY

It is an object to provide a better basis upon which the access networks for IP flows in IFOM is selected.

According to a first aspect, it is presented a method for selectively utilising mobility of Internet Protocol, IP, flows. The method is performed in a packet data network gateway (PGW), and comprises the steps of: establishing an IFOM, IP Flow Mobility, packet data network connection for a mobile terminal using both a first access network, being a 3^{rd} Generation Partnership Program, 3GPP, network, and a second access network, being a non-3GPP network; receiving an IFOM recommendation message for the mobile terminal from a radio access node of the first access network or a radio access node of the second access network, the IFOM recommendation message comprising an indication of recommended access network for at least one IP flow of the mobile terminal; moving at least one IP flow from the first access network to the second access network, or vice versa, in response to receiving the IFOM recommendation message, wherein each one of the at least one IP flow corresponds to a routing filter.

Each routing filter may be defined by one or more of source address, destination address, source port, destination port and protocol type.

The second access network may be a wireless local area network.

The step of moving at least one IP flow may comprise moving the at least one IP flow without changing an IP address associated with the at least one IP flow on the packet data network.

The step of moving at least one IP flow may comprise transmitting at least one updated routing rule to the mobile terminal.

The method may further comprise the step of: obtaining information about which IP flows for the mobile terminal are allowed to be routed via the first access network and/or the second access network, in which case the step of moving at least one IP flow is only performed for IP flows which are allowed to be routed to its recommended access network.

According to a second aspect, it is presented a packet data network gateway arranged to selectively utilise mobility of Internet Protocol, IP, flows. The packet data network gateway comprises: a processor; and a memory storing instructions that, when executed by the processor, causes the packet data network gateway to: establish an IFOM, IP Flow Mobility, packet data network connection for a mobile terminal using both a first access network, being a 3^{rd} Generation Partnership Program, 3GPP, network, and a second access network, being a non-3GPP network; receive an IFOM recommendation message for the mobile terminal from a radio access node of the first access network or a radio access node of the second access network, the IFOM recommendation message comprising an indication of recommended access network for at least one IP flow of the mobile terminal; and move at least one IP flow from the first access network to the second access network, or vice versa, in response to receiving the IFOM recommendation message, wherein each one of the at least one IP flow corresponds to a routing filler.

Each routing filter may be defined by one or more of source address, destination address, source port, destination port and protocol type.

The second access network may be a wireless local area network.

The instructions to move at least one IP flow may comprise instructions that, when executed by the processor, causes the packet data network gateway to move the at least one IP flow without changing an IP address associated with the at least one IP flow on the packet data network.

The instructions to move at least one IP flow may comprise instructions that, when executed by the processor, causes the packet data network gateway to transmit at least one updated routing rule to the mobile terminal.

The packet data network gateway may further comprise instructions that, when executed by the processor, causes the packet data network gateway to obtain information about which IP flows for the mobile terminal are allowed to be routed via the first access network and/or the second access network; in which case the instructions to move at least one IP flow comprise instructions that, when executed by the processor, causes the packet data network gateway to only move IP flows which are allowed to be routed to its recommended access network.

According to a third aspect, it is presented a packet data network gateway comprising: means for establishing an IFOM, Internet Protocol Flow Mobility, packet data network connection for a mobile terminal using both a first access network, being a 3^{rd} Generation Partnership Program, 3GPP, network, and a second access network, being a non-3GPP network; means for receiving an IFOM recommendation message for the mobile terminal from a radio access node of the first access network or a radio access node of the second access network, the IFOM recommendation message comprising an indication of recommended access network for at least one IP flow of the mobile terminal; and means for moving at least one IP, Internet Protocol, flow from the first access network to the second access network, or vice versa, in response to receiving the IFOM recommendation message, wherein each one of the at least one IP flow corresponds to a routing filter.

According to a fourth aspect, it is presented a computer program for selectively utilising mobility of Internet Protocol, IP, flows. The computer program comprises computer program code which, when run on a packet data network gateway causes the packet data network gateway to: establish an IFOM, IP Flow Mobility, packet data network connection for a mobile terminal using both a first access network, being a 3^{rd} Generation Partnership Program, 3GPP, network, and a second access network, being a non-3GPP network; receive an IFOM recommendation message for the mobile terminal from a radio access node of the first access network or a radio access node of the second access network, the IFOM recommendation message comprising an indication of recommended access network for at least one IP flow of the mobile terminal; and move at least one IP flow from the first access network to the second access network, or vice versa, in response to receiving the IFOM recommendation message, wherein each one of the at least one IP flow corresponds to a routing filler.

According to a fifth aspect, it is presented a computer program product comprising a computer program according to the fourth aspect and a computer readable means on which the computer program is stored.

According to a sixth aspect, it is presented a method for selectively indicating recommended use of Internet Protocol Flow Mobility, IFOM. The method is performed in a radio access node of a first access network or a second access network, and comprises the steps of: receiving an indication that IFOM can be utilised for a packet data connection for a mobile terminal; collecting a first set of parameters, the first set of parameters relating to performance for the mobile terminal using the first access network being a ₃rd Generation Partnership Program, 3GPP, network; collecting a second set of parameters, the second set of parameters relating to performance for the mobile terminal using the second access network being a non-3GPP network; determining when the mobile terminal should utilise IFOM at least partly based on the first set of parameters and the second set of parameters; and transmitting an IFOM recommendation message to a packet data network gateway when IFOM should be utilised for the mobile terminal, the IFOM recommendation message comprising an indication of recommended access network for at least one Internet Protocol, IP, flow of the mobile terminal, wherein each one of the at least one IP flow corresponds to a routing filler.

The second access network may be a wireless local area network.

The method may be performed in a radio access node being a radio access node of the first access network.

The method may be performed in a radio access node being an access point of the second access network.

According to a seventh aspect, it is presented a radio access node arranged to be part of a first access network or a second access network, for selectively indicating recommended use of Internet Protocol Flow Mobility, IFOM. The radio access node comprises: a processor; and a memory storing instructions that, when executed by the processor, causes the radio access node to: receive an indication that IFOM can be utilised for a packet data connection for a mobile terminal; collect a first set of parameters, the first set of parameters relating to performance for the mobile terminal using the first access network being a 3^{rd} Generation Partnership Program, 3GPP, network; collect a second set of parameters, the second set of parameters relating to performance for the mobile terminal using the second access network being a non-3GPP network; determine when the mobile terminal should utilise IFOM at least partly based on the first set of parameters and the second set of parameters; and transmit an IFOM recommendation message to a packet data network gateway when IFOM should be utilised for the mobile terminal, the IFOM recommendation message comprising an indication of recommended access network for at least one Internet Protocol, IP, flow of the mobile terminal, wherein each one of the at least one IP flow corresponds to a routing filter.

The second access network may be a wireless local area network. The radio access node may be a radio access node of the first access network.

The radio access node may be an access point of the second access network.

According to an eighth aspect, it is presented a radio access node comprising: means for receiving an indication that Internet Protocol Flow Mobility, IFOM, can be utilised for a packet data connection for a mobile terminal; means for collecting a first set of parameters, the first set of parameters relating to performance for the mobile terminal using a first access network being a 3^{rd} Generation Partnership Program, 3GPP, network; means for collecting a second set of parameters, the second set of parameters relating to performance for the mobile terminal using a second access network being a non-3GPP network, the radio access node being configured to form part of the first access network or the second access network; means for determining when the mobile terminal should utilise IFOM at least partly based on the first set of parameters and the second set of parameters; and means for transmitting an IFOM recommendation message to a packet data network gateway when IFOM should be utilised for the mobile terminal, the IFOM recommendation message comprising an indication of recommended access network for at least one Internet Protocol, IP, flow of the mobile terminal, wherein each one of the at least one IP flow corresponds to a routing filter.

According to a ninth aspect, it is presented a computer program for selectively indicating recommended use of Internet Protocol Flow Mobility, IFOM. The computer program comprises computer program code which, when run on a radio access node forming part of a first access network or a second access network, causes the radio access node to: receive an indication that IFOM can be utilised for a packet data connection for a mobile terminal; collect a first set of parameters, the first set of parameters relating to performance for the mobile terminal using the first access network being a 3^{rd} Generation Partnership Program, 3GPP, network; collect a second set of parameters, the second set of parameters relating to performance for the mobile terminal using the second access network being a non-3GPP network; determine when the mobile terminal should utilise IFOM at least partly based on the first set of parameters and the second set of parameters; and transmit an IFOM recommendation message to a packet data network gateway when IFOM should be utilised for the mobile terminal, the IFOM recommendation message comprising an indication of recommended access network for at least one Internet Protocol, IP, flow of the mobile terminal, wherein each one of the at least one IP flow corresponds to a routing filter.

According to a tenth aspect, it is presented a computer program product comprising a computer program according to the ninth aspect and a computer readable means on which the computer program is stored.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIG. 1 is a schematic diagram illustrating an exemplifying wireless communication system in which embodiments presented herein can be implemented;

FIG. 2 is a sequence diagram illustrating selectively utilising mobility of IP (Internet Protocol) flows in the wireless communication system of FIG. 1 according to one embodiment;

FIG. 3 is a schematic diagram showing some components of the PGW of FIG. 1 according to one embodiment;

FIG. 4 is a schematic diagram showing some components of the radio access nodes of FIG. 1;

FIGS. 5A-B are flow charts illustrating embodiments of methods performed in the PGW of FIG. 1 for selectively utilising mobility of IP flows;

FIG. 6 is a flow chart illustrating embodiments of methods performed in a radio access node;

FIG. 7 is a schematic diagram showing functional modules of the PGW of FIG. 3 according to one embodiment;

FIG. 8 is a schematic diagram showing functional modules of the radio access node 1, 3 of FIG. 4 according to one embodiment; and

FIG. 9 shows one example of a computer program product comprising computer readable means.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

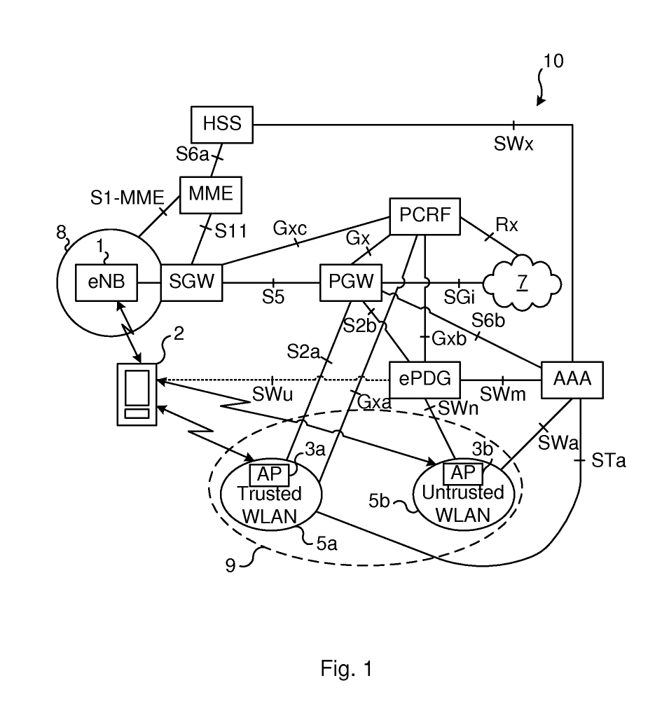

FIG. 1 is a schematic diagram illustrating an exemplifying wireless communication system in which embodiments presented herein can be implemented. The wireless communication system 10 is an LTE based system. It should be pointed out that the terms “LTE” and “LTE based” system used here should be construed to comprise both present and future LTE based systems, such as, for example, advanced LTE systems. It should be appreciated that although FIG. 1 shows a wireless communication system 10 in the form of an LTE based system, the example embodiments herein may also be utilised in connection with other wireless communication systems, such as e.g. Global System for Communication (GSM) or UMTS (Universal Mobile Telecommunications System), comprising nodes and functions that correspond to the nodes and functions of the system in FIG. 1.

The wireless communication system 10 comprises one or more base stations in the form of an eNodeB 1, operatively connected to a Serving Gateway (SGW), in turn operatively connected to a Mobility Management Entity (MME) and a Packet Data Network Gateway (PGW), which in turn is operatively connected to a Policy and Charging Rules Function (PCRF). The eNodeB 1 is a radio access node that interfaces with a mobile terminal 2, providing downlink communication to the mobile terminal 2 and uplink communication from the mobile terminal 2. The term mobile terminal is also known as mobile communication terminal, user equipment (UE), wireless device, user terminal, user agent, wireless terminal, machine-to-machine device etc., and can be, for example, what today are commonly known as a mobile phone or a tablet/laptop with wireless connectivity.

The eNodeB 1 of the system forms part of the E-UTRAN (Evolved Universal Terrestrial Radio Access Network) for LTE communicating with the mobile terminal 2 over an air interface such as LTE-Uu. The core network in LTE is known as Evolved Packet Core (EPC), and the EPC together with the E-UTRAN is referred to as Evolved Packet System (EPS). The SGW routes and forwards user data packets over the S1-U interface. For idle state mobile terminals, the SGW terminates the downlink data path and triggers paging when downlink data arrives for the mobile terminal 2. The SGW may also perform replication of the user traffic in case of lawful interception. The SGW communicates with the MME via interface S11 and with the PGW via the S5 interface. Further, the SGW may communicate with the UMTS radio access network UTRAN and with the GSM EDGE (“Enhanced Data rates for GSM Evolution”) Radio Access Network (GERAN) via the S12 interface via radio base stations referred to as NodeBs in UTRAN and Base Station Transceivers (BTSs).

The MME also terminates the S6a interface, towards the Home Subscriber Database (HSS). The MME communicates with the E-UTRAN via an S1-MME interface.

The PGW provides connectivity to the mobile terminal 2 to external packet data networks (PDNs) 7 by being the point of exit and entry of traffic for the mobile terminal 2. A mobile terminal 2 may have simultaneous connectivity with more than one PGW for accessing multiple PDNs. The PGW performs policy enforcement, packet filtering for each user, charging support, lawful interception and packet screening. Another role of the PGW is to act as the anchor for mobility between 3GPP and non-3GPP technologies such as Wireless Local Area Network (WLAN) and 3GPP2 (CDMA (Code Division Multiple Access) 1X and EvDO (Evolution-Data Optimised)). WLAN is also known as Wi-Fi. The interface between the PGW and the packet data network 7 is referred to as the SGi. The packet data network 7 could be any suitable packet data network, such as the Internet or alternatively an operator specific network, a private packet data network or an intra operator packet data network, e.g. for provision of IP Multimedia Subsystem (IMS) services.

The PCRF determines policy rules in real-time with respect to the mobile terminals of the system. This may e.g. include aggregating information in real-time to and from the core network and operational support systems, etc. of the system so as to support the creation of rules and/or automatically making policy decisions for user radio terminals currently active in the system based on such rules or similar. The PCRF provides such rules and/or policies or similar to be used by the acting PGW as a Policy and Charging Enforcement Function (PCEF) via interface Gx, to the SGW via interface Gxc, to a trusted WLAN 5a via interface Gxa and to an Evolved Packet Data Gateway (ePDG) via interface Gxb. When S5, S2a or S2b are based on GTP (GPRS tunneling protocol (GTP)), then polices are sent over GTP. The PCRF further communicates with the packet data network 7 via the Rx interface.

The system further comprises a 3GPP Authentication, Authorisation and Accounting (AAA) server, which takes care of the authentication, authorisation and accounting of the mobile terminal 2 connecting to the EPC network via an untrusted WLAN 5b and ePDG across interface SWm. The ePDG further connects to the PGW via interface S2b using GTP or Proxy Mobile IPv6 (PMIP) and to the untrusted WLAN 5b via interface SWn. The 3GPP AAA server also connects to the HSS via interface SWx, to the PGW via interface S6b, to the trusted WLAN 5a via interface STa and to the untrusted WLAN 5b via interface SWa. The mobile terminal 2 can in this way connect to the trusted WLAN 5a using a trusted access point 3a and/or the untrusted WLAN 5b using an untrusted access point 3b. The trusted access point 3a connects to the PGW via a Trusted Wireless Access Gateway (TWAG). The trusted access point 3a thus provides a gateway for the mobile terminal 2 between the EPC network and trusted WLAN and further connects to the PGW via interface S2a.

Using wireless communication system 10, two access networks 8, 9 can be used for communication between the mobile terminal 2 and the packet data network 7. A first access network is a 3GPP network 8, in this example an E-UTRAN of an LTE network. A second access network 9 is a non-3GPP network, in this example a WLAN network. The trusted access point 3a and the untrusted access point 3b are thus radio access nodes for the second (non-3GPP) access network 9.

In one embodiment, a trusted WLAN is managed by an operator (e.g. an operator hotspot) whereas the untrusted WLAN is not managed by the operator (e.g. a WiFi access point at home). The ePDG acts as a security gateway between the untrusted WLAN 5b and the core network of the operator. The mobile terminal 2 sets up a secure tunnel to the ePDG, and there is the S2b interface between the ePDG and the PGW. For the trusted WLAN 5a, there is a point-to-point interface between the mobile terminal 2 and the trusted access point 3a, and the Sea interface between the TWAG (connected to the trusted access point 3a) and the PGW.

PDN connections can be setup over the 3GPP access network 8 or over the non-3GPP access network 9. A mobile terminal may have one or more PDN connections over a 3GPP access network, and/or one or more PDN connections over a non-3GPP access network.

Every PDN connection consists of one or more bearers. A bearer uniquely identifies traffic flows that receive a common QoS (Quality of Service) treatment between a mobile terminal and a PGW. Each bearer over a particular access network has a unique bearer ID. The bearer IDs assigned for a specific mobile terminal on the S2a/S2b interfaces are independent of the bearer IDs assigned for the same mobile terminal on the S5 interface and may overlap in value.

On the 3GPP access network 8, the bearer is end-to-end between the mobile terminal and the PGW. The bearer ID is known by the PGW, the MME, the eNodeB and the mobile terminal. On the non-3GPP access network, there is currently no bearer concept between the mobile terminal and TWAG 3a or the ePDG. The bearer concept is only defined between the PGW and the TWAG 3a and the ePDG; i.e. it is only defined over the S2a/S2b interfaces. In this case, the bearer ID is known by the PGW, the trusted access point 3a and ePDG but not by the mobile terminal. Regardless of access network type, the PCRF is not aware of bearer IDs.

Every PDN connection has at least one bearer and this bearer is called the default bearer. All additional bearers on the PDN connection are called dedicated bearers

A bearer carries traffic in the form of IP packets. Which traffic is carried on a bearer is defined by IP fillers. A filler is an IP n-tuple where each element in the tuple contains a value, a range, or a wildcard. An n-tuple is also known as an IP flow.

An example of a 5-tuple is (destination IP=83.50.20.110, source IP=145.45.68.201, destination port=80, source port=*, protoco1=TCP). This 5-tuple defines a source and destination IP address, a source and destination port, and a protocol. The source port is a wildcard. Traffic matching this 5-tuple filter would be all TCP traffic from IP=145.45.68.201 to IP=83.50.20.110 and port=80.

A traffic flow template, TFT, contains one or more fillers, such as n-tuples. The TFT is one form of a routing rule. Every bearer has a TFT. One bearer within a PDN connection and access network may lack an explicit TFT (this bearer is typically the default bearer). Implicitly such bearer has a TFT with a single filler matching all packets.

As described above, IFOM stands for IP flow mobility. An IFOM PDN connection is a special PDN connection that maintains a single IP address/prefix but can be routed over multiple access networks simultaneously. The mobile terminal and the PGW negotiate which IP flow gets routed over which access network.

Even though an IFOM PDN connection may be routed over multiple access networks simultaneously, the bearers on each access network within that PDN connection are independent of each other.

In order to negotiate which IP flow shall be routed over which access network, routing rule update procedures are defined. A routing rule update can be initiated either from the mobile terminal or from the PGW.

A control entity in the radio access network (RAN) 8 decides when the mobile terminal shall perform a handover from one eNodeB to another eNodeB. Such control entity may be co-located with an eNodeB. While such a control entity is aware of bearers, it has no knowledge of PDN connections or IP flows. The decision made in the RAN is based on multiple inputs with a goal to increase the number of satisfied users in the network. The input information can comprise any one or more of data about network topology, current radio conditions, load, mobile terminal capabilities, cell capabilities, traffic conditions and/or subscription details.

In the prior art, a main problem with network-initiated IFOM solution is that all the above information is not available in the PGW where the routing rule update procedure is triggered. For example, some subscription based information can be made available in the PGW and the PGW is also aware of mobile terminal traffic volume and some mobile terminal capabilities but much of the other information is not feasible to be made available in the PGW. The PGW merely knows that the mobile terminal is connected via both 3GPP and non-3GPP access network but it doesn't have any detailed information about the conditions in these access networks, in particular not about the radio related conditions.

Therefore, it would be beneficial to be able to have the PGW decision also based on the normal information used for handover decision in the 3GPP access network to maximize the number of satisfied users in the network. A similar problem applies also for mobile terminal initiated IFOM (i.e. not all information is available at the mobile terminal, although the mobile terminal typically knows more than the PGW about the access network related conditions, e.g. the radio link quality for the mobile terminal in the different cells).

According to embodiments presented herein, the PGW decides when to move an IP flow from one access network to another based on a recommendation from the RAN. The RAN, in turn bases this recommendation on data from both the 3GPP network and the non-3GPP network. In this way, the decision when to move a flow takes into account information about both access networks.

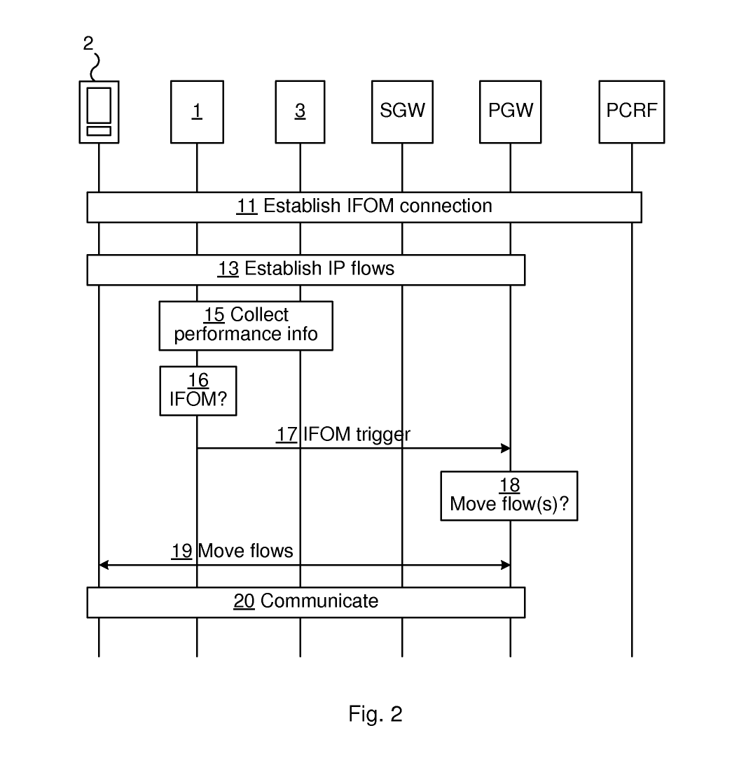

FIG. 2 is a sequence diagram illustrating selectively utilising mobility of IP flows in the wireless communication system of FIG. 1 according to one embodiment. This will be illustrated with an example.

First, an IFOM connection is established ii. This comprises the mobile terminal and the PGW establishing a PDN connection over the 3GPP access network. Optionally, the PGW retrieves additional information from the PCRF. Alternatively or additionally, the mobile terminal can indicate whether it supports network-based IFOM.

The mobile terminal and the PGW then adds a non-3GPP access network connection to the established PDN connection. Optionally, the PGW retrieves additional information from the PCRF. It is to be noted that it is equally possible that the non-3GPP access network connection is established first and then the 3GPP access network connection is added.

Once the PDN connection is set up, the mobile terminal establishes 13 one or more IP flows. In this example, these IP flows are initially on the 3GPP access network. In this example, the mobile terminal establishes three IP Flows. These IP flows are identified by TFTi/RRi, TFT2/RR2 and TFT3/RR2 respectively.

The PGW is aware of the active three IP flow(s) and that the mobile terminal is connected with the same PDN connection both via 3GPP access network and non-3GPP access network. The PGW awareness of the active IP flow(s) may come from PCRF as triggered by a Traffic Detection Function or by traffic analysis in the PGW. The PGW is also aware of how the different IP flows are allowed on 3GPP and non-3GPP access network. The awareness of if IP flows are allowed on 3GPP and/or non-3GPP access network may come from the PCRF. In this example, the IP Flows 1 and 2 are allowed on non-3GPP access network, and IP Flow 3 is not allowed on non-3GPP access network. At this stage, however, the PGW does not trigger any routing rule updates.

A radio access node 1, 3 of 3GPP access network or the non-3GPP access network then collects 15 mobile terminal and network information for both 3GPP access network and non-3GPP access network.

The radio access node 1, 3 determines 16, based on the network information collected, whether IFOM should be utilised.

When IFOM should be utilised, the radio access node 1, 3 sends an IFOM recommendation message 17 to the PGW (shown as IFOM trigger in FIG. 2). As the radio access node is not aware of the different active IP flows for the mobile terminal, the trigger is generic and just indicates that access via the other access network is now possible and preferred for some IP flows.

The PGW receives the IFOM recommendation message and makes a decision whether to move 18 one or more IP flows based on this recommendation. The decision is based, for example, on information available on IP flows and if these are allowed on the access network indicated in the IFOM recommendation message 17. This information may have been received from the PCRF as described above or can be information locally configured in the PGW. The PGW may also contact the PCRF as part of this step.

When the PGW decides to move flows, the PGW moves one or more flows 19 by triggering network initiated routing rule update towards the mobile terminal. In the mentioned example, for IP Flows 1 and 2 (identified by RR1 and RR2) are moved as these are allowed on non-3GPP access network. This step can be performed over either 3GPP access network or non-3GPP access network and is based on the particular method available in the selected access network. There are also differences in how this step would be performed over S2a and S2b based solutions.

Once the move is effected, communication 20 occurs accordingly. In the mentioned example, this means that IP flow(s) 1 and 2 are now over the non-3GPP access network.

In addition to the steps described above, there can also exist an optional initial signaling from the core network to the radio access node 1 of the 3GPP access network indicating that the mobile terminal is IFOM-capable or is using IFOM. This indication can e.g. be provided in the establish IFOM connection step 11 above. In one example, this “using IFOM” indication is after the mobile terminal has added non-3GPP access network to the IFOM PDN connection. This indication can be used to activate the sending of the IFOM triggers from the radio access nodes as described above. In a similar way, another indication of “mobile terminal not using IFOM” can be used to deactivate the sending of the IFOM triggers from the radio access nodes.

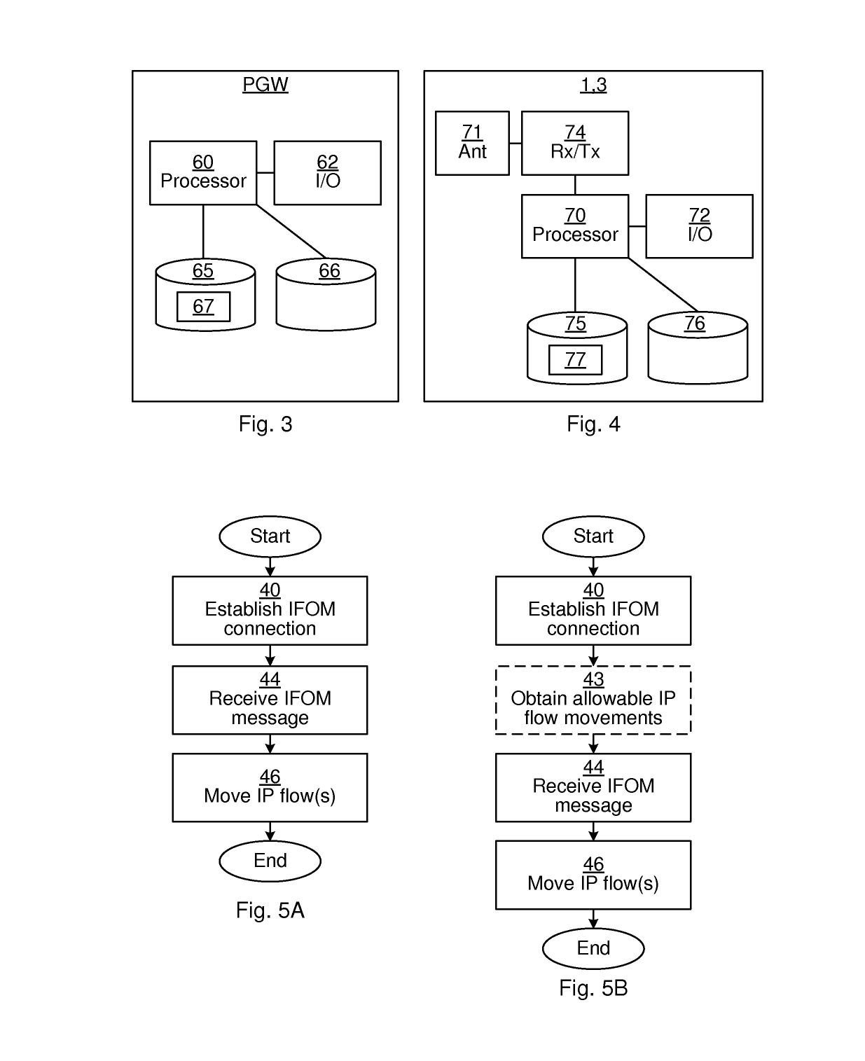

FIG. 3 is a schematic diagram showing some components of the PGW of FIG. 1 according to one embodiment. A processor 60 is provided using any combination of one or more of a suitable central processing unit (CPU), multiprocessor, microcontroller, digital signal processor (DSP), application specific integrated circuit etc., capable of executing software instructions 67 stored in a memory 65, which can thus be a computer program product. The processor 60 can be configured to execute the method described with reference to FIGS. 5A-B below.

The memory 65 can be any combination of read and write memory (RAM) and read only memory (ROM). The memory 65 also comprises persistent storage, which, for example, can be any single one or combination of magnetic memory, optical memory, solid state memory or even remotely mounted memory.

A data memory 66 is also provided for reading and/or storing data during execution of software instructions in the processor 60. The data memory 66 can be any combination of read and write memory (RAM) and read only memory (ROM).

The PGW further comprises an I/O interface 62 for communicating with other external entities. Optionally, the I/O interface 62 also includes a user interface.

FIG. 4 is a schematic diagram showing some components of the radio access nodes 1, 3a, 3b of FIG. 1. Both radio access nodes being access points 3a, 3b are here referred to by a single reference numeral 3. While the radio access nodes 1, 3a, 3b have variations depending on the access network used, the components shown in FIG. 4 are part of all types of radio access nodes.

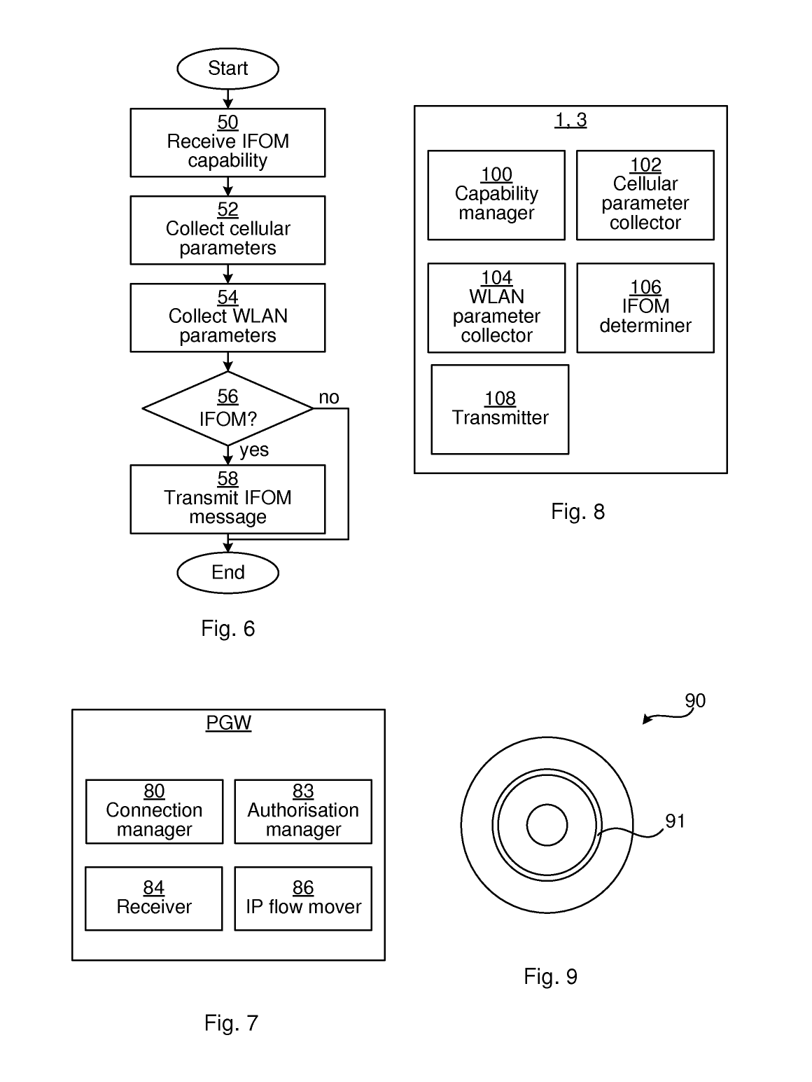

A processor 70 is provided using any combination of one or more of a suitable central processing unit (CPU), multiprocessor, microcontroller, digital signal processor (DSP), application specific integrated circuit etc., capable of executing software instructions 77 stored in a memory 75, which can thus be a computer program product. The processor 70 can be configured to execute the method described with reference to FIG. 6 below.

The memory 75 can be any combination of read and write memory (RAM) and read only memory (ROM). The memory 75 also comprises persistent storage, which, for example, can be any single one or combination of magnetic memory, optical memory, solid state memory or even remotely mounted memory.

A data memory 76 is also provided for reading and/or storing data during execution of software instructions in the processor 70. The data memory 76 can be any combination of read and write memory (RAM) and read only memory (ROM).

The radio access node 1, 3 further comprises an I/O interface 72 for communicating with other external entities, e.g. uplink in the network. Optionally, the I/O interface 72 also includes a user interface.

The radio access node 1, 3 also comprises one or more transceivers 74, comprising analogue and digital components, and a suitable number of antennas 71 for wireless communication with wireless terminals as shown in FIG. 1. The transceiver(s) 74 and antenna(s) 71 are adapted to the access network used.

Other components of the radio access node 1, 3 are omitted here in order not to obscure the concepts presented herein.

FIGS. 5A-B are flow charts illustrating embodiments of methods performed in the PGW of FIG. 1 for selectively utilising mobility of IP flows.

In an establish IFOM connection step 40, an IFOM packet data network connection for a mobile terminal is established using both a first access network, being a 3GPP network and a second access network, being a non-3GPP network. For example, as shown in FIG. 1, the second access network can be a wireless local area network. This corresponds to step 11 of FIG. 2.

In a receive IFOM message step 44, an IFOM recommendation message for the mobile terminal is received from a radio access node of the first access network or a radio access node of the second access network. The IFOM recommendation message comprises an indication of recommended access network for at least one IP flow of the mobile terminal. This corresponds to receiving the IFOM trigger message 17 of FIG. 2.

In a move IP flow(s) step 46, at least one IP flow is moved from the first access network to the second access network, or vice versa, in response to receiving the IFOM recommendation message. It is to be noted that the IFOM recommendation message is only a recommendation ant the PGW still decides what, if any, IP flows to move. The decision can move all IP flows corresponding to the recommendation, some IP flows corresponding to the recommendation or no IP flows at all.

This step corresponds to the move flow(s) step 18 of FIG. 2. Each one of the at least one IP flow corresponds to a routing filler. In one embodiment, each routing filter is defined by one or more of source address, destination address, source port, destination port and protocol type, called an n-tuple. For instance, a 5-tuple can be used, defining all of the parameters of source address, destination address, source port, destination port and protocol type. Each one of these parameter can be a single value, a range of values, a plurality of ranges, optionally using wildcards.

The moving of the at least one IP flow can be effected by transmitting at least one updated routing rule to the mobile terminal, and optionally applying a corresponding routing rule in the PGW.

One advantage of using IFOM is that the moving of the at least one IP flow can be performed without changing an IP address associated with the at least one IP flow on the packet data network. In other words, the move is transparent for any nodes connected to the mobile terminal via the packet data network.

It is to be noted that the order shown in FIG. 5A is not necessary; for instance, some steps can be performed continuously, such as the establish IFOM connection step 40.

Looking now to FIG. 5B, only new or modified steps compared to the method illustrated by the flow chart of FIG. 5A will be described.

In an obtain allowable IP flow movements step 43, information is obtained which indicates which IP flows for the mobile terminal are allowed to be routed via the first access network and/or the second access network. This step is included in steps ii of FIG. 2 and is performed prior to the move IP flow(s) step 46.

In such an embodiment, the move IP flow(s) step 46 is only performed for IP flows which are allowed to be routed to its recommended access network. For instance, there may be instances where voice calls are only allowed to be routed via 3GPP access networks.

FIG. 6 is a flow chart illustrating embodiments of methods performed in a radio access node. The radio access node can be a radio access node of the first access network, i.e. a radio base station (e.g. an eNodeB) of the 3GPP network. Alternatively, the radio access node is an access point of the second access network being a non-3GPP network. The method is performed for selectively indicating recommended use of IFOM.

In a receive IFOM capability step 50, an indication that IFOM can be utilised for a packet data connection for a mobile terminal is received

In a collect cellular parameters step 52, a first set of parameters is collected. This step corresponds to the collect performance info step 15 of FIG. 2. The first set of parameters relates to performance for the mobile terminal using the first access network being a 3GPP network. The first set of parameters can e.g. comprise information that is normally available for handover decisions within 3GPP access networks e.g. radio network topology information, radio link quality for the mobile terminal in the current cell and other cells as measured by the mobile terminal, cell load in the current cell for the mobile terminal and in other cells as measured by the mobile terminal, mobile terminal capabilities, cell capabilities (current cell and other cells as measured by the mobile terminal), mobile terminal activity/traffic volume and subscription based information (received from the core network).

In a collect WLAN parameters step 54, a second set of parameters is collected. This step corresponds to the collect performance info step 15 of FIG. 2. The second set of parameters relates to performance for the mobile terminal using the second access network being a non-3GPP network, such as WLAN (but could be other non-3GPP network).

Different solutions can be used to make second set of parameters the information available e.g. on the 3GPP network side when this method is performed in a radio access node of the 3GPP network. For instance, network side interfaces between the 3GPP access network and the non-3GPP access network can be used to exchange different information (for example about load in the different access networks or cells in the different access networks). As an example, an X2-based interface between an eNodeB and trusted access point can be used. Alternatively or additionally, new signaling from the mobile terminal can be used to provide non-3GPP access network measurements to the 3GPP access network. An example: the mobile terminal reports Wi-Fi received signal strength (or other similar measurement), Wi-Fi Load and WAN metrics of some Wi-Fi access points to the eNodeB.

In a conditional IFOM step 56, corresponding to the IFOM step 16 of FIG. 2, it is determined when the mobile terminal (2) should utilise IFOM. This determination is at least partly based on the first set of parameters and the second set of parameters. If it is determined that IFOM should be utilised, the method proceeds to a transmit IFOM message step 58. Otherwise, the method ends.

In the transmit IFOM message step 58, an IFOM recommendation message is transmitted to a PGW. The IFOM recommendation message corresponds to the IFOM trigger message 17 of FIG. 2 and comprises an indication of recommended access network for at least one IP flow of the mobile terminal. Each one of the at least one IP flow corresponds to a routing filler. The IFOM recommendation message does not need to contain the IP filters. Instead, the recommendation message may contain a bearer ID, or can just be an indication that all (allowable) traffic for a particular mobile terminal is recommended to be moved.

Multiple different signaling paths are possible for the sending of the IFOM message to the PGW. In a first communication path, the IFOM message is sent from 3GPP access network using control plane signaling. One example is the following path: eNodeB to MME to SGW to PGW, and another example can be: eNodeB to MME to PCRF to PGW. In both cases, the mobile terminal can be identified with the different mobile terminal identities available in the different nodes.

In a second communication path, the IFOM message is sent from 3GPP access network using user plane transmission. In this case the IFOM message can be piggy-packed in the user plane transmission, for example in GTP-U headers in the following path: eNodeB to SGW to PGW. In this case, the mobile terminal can be identified with the GTP-U related identifiers.

In a third communication path, the IFOM message is sent from non-3GPP access network using control plane signaling. This could be based on GTP-C additions for example in the S2a and S2b interfaces. In addition, there may be additional signaling within the non-3GPP access network towards the ePDG (S2b) or trusted access point (S2a).

In a fourth communication path, the IFOM message is sent from non-3GPP access network using user plane transmission. This could be based on GTP-U additions for example in the S2a and S2b interfaces. In addition, there may be additional signaling within the non-3GPP access network towards the ePDG (S2b) or trusted access point (S2a).

In a fifth communication path, the IFOM message is sent using off-path communication. From 3GPP access network, a new interface is created between the eNodeB and the PGW. A specific mobile terminal identity needs to be also included in the signaling and one such possibility would be the mobile terminal IP-address for the PDN connection (if the eNodeB sniffs this identity). From non-3GPP access network, this works in a similar way as for 3GPP access network. In this case even the IMSI (International Mobile Subscriber Identity) may be available in the non-3GPP access network and can be included in the IFOM message.

Nevertheless, the PGW still has the power to decide whether to accept the recommendation to use IFOM for the indicated IP flow(s) or not.

It is to be noted that the order shown in FIG. 6 is not necessary; for instance, some steps can be performed continuously, such as the collect cellular parameters step 52 and the collect WLAN parameters step 54.

FIG. 7 is a schematic diagram showing functional modules of the PGW of FIG. 3 according to one embodiment. The modules are implemented using software instructions such as a computer program executing in the PGW. The modules correspond to the steps in the methods illustrated in FIGS. 5A-B.

A connection manager 80 is configured to establish an IFOM packet data network connection for a mobile terminal using both a first access network, being a 3GPP network, and a second access network, being a non-3GPP network. This module corresponds to the establish IFOM connection step 40 of FIGS. 5A-B.

An authorisation manager 83 is configured to obtain information about which IP flows for the mobile terminal are allowed to be routed via the first access network and/or the second access network. This module corresponds to the obtain allowable IP flow movements step 43 of FIG. 5B.

A receiver 84 is configured to receive an IFOM recommendation message for the mobile terminal from a radio access node of the first access network or a radio access node of the second access network. This module corresponds to the receive IFOM message step 44 of FIGS. 5A-B.

An IP flow mover 86 is configured to move at least one IP flow from the first access network to the second access network, or vice versa, in response to receiving the IFOM recommendation message, wherein each one of the at least one IP flow corresponds to a routing filter. This module corresponds to the move IP flow(s) step 46 of FIGS. 5A-B.

FIG. 8 is a schematic diagram showing functional modules of the radio access node 1, 3 of FIG. 4 according to one embodiment. The modules are implemented using software instructions such as a computer program executing in the radio access node 1, 3. The modules correspond to the steps in the methods illustrated in FIG. 6.

A capability manager 100 is configured to receive an indication that IFOM can be utilised for a packet data connection for a mobile terminal. This module corresponds to the receive IFOM capability step 50 of FIG. 6.

A cellular parameter collector 102 is configured to collect a first set of parameters relating to performance for the mobile terminal using the first access network being a 3GPP network. This module corresponds to the collect cellular parameters step 52 of FIG. 6.

A WLAN parameter collector 104 is configured to collect a second set of parameters relating to performance for the mobile terminal using the second access network being a non-3GPP network. This module corresponds to the collect WLAN parameters step 54 of FIG. 6.

An IFOM determiner 106 is configured to determine when the mobile terminal should utilise IFOM, at least partly based on the first set of parameters and the second set of parameters. This module corresponds to the conditional IFOM step 56 of FIG. 6.

A transmitter 108 is configured to transmit an IFOM recommendation message to a packet data network gateway. This module corresponds to the transmit IFOM message step 58 of FIG. 6.

FIG. 9 shows one example of a computer program product comprising computer readable means. On this computer readable means a computer program 91 can be stored, which computer program can cause a processor to execute a method according to embodiments described herein. In this example, the computer program product is an optical disc, such as a CD (compact disc) or a DVD (digital versatile disc) or a Blu-Ray disc. As explained above, the computer program product could also be embodied in a memory of a device, such as the computer program product 65 of FIG. 3 or 75 of FIG. 4. While the computer program 91 is here schematically shown as a track on the depicted optical disk, the computer program can be stored in any way which is suitable for the computer program product, such as a removable solid state memory, e.g. a Universal Serial Bus (USB) drive.

The invention has mainly been described above with reference to a few embodiments. However, as is readily appreciated by a person skilled in the art, other embodiments than the ones disclosed above are equally possible within the scope of the invention, as defined by the appended patent claims.

1-26. (canceled)

27. A method for selectively utilizing mobility of Internet Protocol (IP) flows, the method being performed in a packet data network gateway (PGW) and comprising the steps of:
establishing an IP Flow Mobility (IFOM) packet data network connection for a mobile terminal using both a first access network, being a 3rd Generation Partnership Program (3GPP) network, and a second access network, being a non-3GPP network;
receiving an IFOM recommendation message for the mobile terminal from a radio access node of the first access network or a radio access node of the second access network, the IFOM recommendation message comprising an indication of recommended access network for at least one IP flow of the mobile terminal; and
moving at least one IP flow from the first access network to the second access network, or vice versa, in response to receiving the IFOM recommendation message, wherein each one of the at least one IP flow corresponds to a routing filter.

28. The method of claim 27, wherein each routing filter is defined by one or more of source address, destination address, source port, destination port and protocol type.

29. The method of claim 27, wherein the second access network is a wireless local area network.

30. The method of claim 27, wherein moving at least one IP flow comprises moving the at least one IP flow without changing an IP address associated with the at least one IP flow on the packet data network.

31. The method of claim 27, wherein moving at least one IP flow comprises transmitting at least one updated routing rule to the mobile terminal.

32. The method of claim 27, further comprising obtaining information about which IP flows for the mobile terminal are allowed to be routed via the first access network and/or the second access network; and wherein moving at least one IP flow is only performed for IP flows that are allowed to be routed to the recommended access network.

33. A packet data network gateway (PGW) arranged to selectively utilize mobility of Internet Protocol (IP) flows, the packet data network gateway (PGW) comprising:
a processor; and
a memory storing instructions that, when executed by the processor, cause the PGW to:
establish an IP Flow Mobility (IFOM) packet data network connection for a mobile terminal using both a first access network, being a 3rd Generation Partnership Program (3GPP) network, and a second access network, being a non-3GPP network;
receive an IFOM recommendation message for the mobile terminal from a radio access node of the first access network or a radio access node of the second access network, the IFOM recommendation message comprising an indication of recommended access network for at least one IP flow of the mobile terminal; and
move at least one IP flow from the first access network to the second access network, or vice versa, in response to receiving the IFOM recommendation message, wherein each one of the at least one IP flow corresponds to a routing filter.

34. The packet data network gateway (PGW) of claim 33, wherein each routing filter is defined by one or more of source address, destination address, source port, destination port and protocol type.

35. The packet data network gateway (PGW) of claim 33, wherein the second access network is a wireless local area network.

36. The packet data network gateway (PGW) of claim 33, wherein the instructions to move at least one IP flow comprise instructions that, when executed by the processor, cause the packet data network gateway to move the at least one IP flow without changing an IP address associated with the at least one IP flow on the packet data network.

37. The packet data network gateway (PGW) of claim 33, wherein the instructions to move at least one IP flow comprise instructions that, when executed by the processor, cause the packet data network gateway to transmit at least one updated routing rule to the mobile terminal.

38. The packet data network gateway (PGW) of claim 33, further comprising instructions that, when executed by the processor, cause the packet data network gateway to obtain information about which IP flows for the mobile terminal are allowed to be routed via the first access network and/or the second access network; and wherein the instructions to move at least one IP flow comprise instructions that, when executed by the processor, cause the packet data network gateway to only move IP flows which are allowed to be routed to its recommended access network.

39. A packet data network gateway (PGW) comprising:
means for establishing an Internet Protocol Flow Mobility (IFOM) packet data network connection for a mobile terminal using both a first access network, being a 3rd Generation Partnership Program (3GPP) network, and a second access network, being a non-3GPP network;
means for receiving an IFOM recommendation message for the mobile terminal from a radio access node of the first access network or a radio access node of the second access network, the IFOM recommendation message comprising an indication of recommended access network for at least one Internet Protocol (IP) flow of the mobile terminal; and
means for moving at least one IP flow from the first access network to the second access network, or vice versa, in response to receiving the IFOM recommendation message, wherein each one of the at least one IP flow corresponds to a routing filter.

40. A non-transitory computer-readable medium comprising, stored thereupon, a computer program for selectively utilizing mobility of Internet Protocol (IP) flows, the computer program comprising computer program code that, when run on a packet data network gateway (PGW) causes the PGW to:
establish an IP Flow Mobility (IFOM) packet data network connection for a mobile terminal using both a first access network, being a 3rd Generation Partnership Program (3GPP) network, and a second access network, being a non-3GPP network;
receive an IFOM recommendation message for the mobile terminal from a radio access node of the first access network or a radio access node of the second access network, the IFOM recommendation message comprising an indication of recommended access network for at least one IP flow of the mobile terminal; and
move at least one IP flow from the first access network to the second access network, or vice versa, in response to receiving the IFOM recommendation message, wherein each one of the at least one IP flow corresponds to a routing filter.

41. A method for selectively indicating recommended use of Internet Protocol Flow Mobility (IFOM) the method being performed in a radio access node of a first access network or a second access network, and comprising:
receiving an indication that IFOM can be utilized for a packet data connection for a mobile terminal;
collecting a first set of parameters, the first set of parameters relating to performance for the mobile terminal using the first access network being a 3rd Generation Partnership Program (3GPP) network;
collecting a second set of parameters, the second set of parameters relating to performance for the mobile terminal using the second access network being a non-3GPP network;
determining when the mobile terminal should utilize IFOM at least partly based on the first set of parameters and the second set of parameters; and
transmitting an IFOM recommendation message to a packet data network gateway when IFOM should be utilized for the mobile terminal, the IFOM recommendation message comprising an indication of recommended access network for at least one Internet Protocol (IP) flow of the mobile terminal, wherein each one of the at least one IP flow corresponds to a routing filter.

42. The method of claim 41, wherein the second access network is a wireless local area network.

43. The method of claim 41, wherein the method is performed in a radio access node being a radio access node of the first access network.

44. The method of claim 41, wherein the method is performed in a radio access node being an access point of the second access network.

45. A radio access node arranged to be part of a first access network or a second access network, for selectively indicating recommended use of Internet Protocol Flow Mobility (IFOM), the radio access node comprising:
a processor; and
a memory storing instructions that, when executed by the processor, cause the radio access node to:
receive an indication that IFOM can be utilized for a packet data connection for a mobile terminal;
collect a first set of parameters, the first set of parameters relating to performance for the mobile terminal using the first access network being a 3rd Generation Partnership Program (3GPP) network;
collect a second set of parameters, the second set of parameters relating to performance for the mobile terminal using the second access network being a non-3GPP network;
determine when the mobile terminal should utilize IFOM at least partly based on the first set of parameters and the second set of parameters; and
transmit an IFOM recommendation message to a packet data network gateway when IFOM should be utilized for the mobile terminal, the IFOM recommendation message comprising an indication of recommended access network for at least one Internet Protocol (IP) flow of the mobile terminal, wherein each one of the at least one IP flow corresponds to a routing filter.

46. The radio access node of claim 45, wherein the second access network is a wireless local area network.

47. The radio access node of claim 45, wherein the radio access node is a radio access node of the first access network.

48. The radio access node of claim 45, wherein the radio access node is an access point of the second access network.

49. A radio access node comprising:
means for receiving an indication that Internet Protocol Flow Mobility (IFOM) can be utilized for a packet data connection for a mobile terminal;
means for collecting a first set of parameters, the first set of parameters relating to performance for the mobile terminal using a first access network being a 3rd Generation Partnership Program (3GPP) network;
means for collecting a second set of parameters, the second set of parameters relating to performance for the mobile terminal using a second access network being a non-3GPP network, the radio access node being configured to form part of the first access network or the second access network;
means for determining when the mobile terminal should utilize IFOM at least partly based on the first set of parameters and the second set of parameters; and
means for transmitting an IFOM recommendation message to a packet data network gateway when IFOM should be utilized for the mobile terminal, the IFOM recommendation message comprising an indication of recommended access network for at least one Internet Protocol (IP) flow of the mobile terminal, wherein each one of the at least one IP flow corresponds to a routing filter.

50. A non-transitory computer-readable medium comprising, stored thereupon, a computer program for selectively indicating recommended use of Internet Protocol Flow Mobility (IFOM) the computer program comprising computer program code that, when run on a radio access node forming part of a first access network or a second access network, causes the radio access node to:
receive an indication that IFOM can be utilized for a packet data connection for a mobile terminal;
collect a first set of parameters, the first set of parameters relating to performance for the mobile terminal using the first access network being a 3rd Generation Partnership Program (3GPP) network;
collect a second set of parameters, the second set of parameters relating to performance for the mobile terminal using the second access network being a non-3GPP network;
determine when the mobile terminal should utilize IFOM at least partly based on the first set of parameters and the second set of parameters; and
transmit an IFOM recommendation message to a packet data network gateway when IFOM should be utilized for the mobile terminal, the IFOM recommendation message comprising an indication of recommended access network for at least one Internet Protocol (IP) flow of the mobile terminal, wherein each one of the at least one IP flow corresponds to a routing filter.
